(19) United States
(12) Patent Application Publication
(10) Pub. No.: US 2003/0235671 A1
(43) Pub. Date: Dec. 25, 2003

(54) Tubular member

(76) Inventor: Yoshinori Sano, Hyogo (JP)

Correspondence Address: BIRCH STEWART KOLASCH & BIRCH, PO BOX 747, FALLS CHURCH, VA, 22040-0747, US

(21) Appl. No.: 10/414,124

(22) Filed: Apr. 16, 2003

(30) Foreign Application Priority Data
May 7, 2002 (JP) 2002-131787

(51) Int. Cl. B32B 1/08

(52) U.S. Cl. 428/36.91

(57) ABSTRACT

A tubular member (10) including a laminate of a plurality of prepregs each containing a matrix resin and a reinforcing fiber impregnated with the matrix resin. A polarizing prepreg (15) whose reinforcing fiber consists of a glass fiber and whose matrix resin contains a polarizing material is disposed at least at an outermost layer of the laminate. The polarizing prepreg (15) and the prepregs (11 to 14) other than the polarizing prepreg (15) are formed integrally to obtain the tubular member (10). The polarizing prepreg (15) is disposed in such away as to cover the surface of the laminate entirely or partly.

### BACKGROUND OF THE INVENTION

1. Field of the Invention

The present invention relates to a tubular member and more particularly to a tubular member having a construction allowing decoration to be applied uniformly to the surface thereof and preventing a decoration layer from separating therefrom.

2. Description of the Related Art

The tubular member to be used for a golf club shaft, a tennis racket, a badminton racket, a fishing rod, and the like is composed mainly of a fiber reinforced resinous material such as a carbon prepreg. The fiber reinforced resinous material is popular because it has a high strength and a suitable flexibility and is lightweight. Therefore various types of tubular members having functions conforming to purposes are provided.

In recent years, the tubular member having a beautiful external appearance in addition to the above-described fundamental functions are increasingly commercially available. Decoration for the products has become very important, because the decoration is considered to display the characteristic thereof. In view of such a trend, there have been developed techniques of forming a metal film on the surface of a material for the tubular member to lap the surface thereof to a mirror-like surface finish to thereby provide the product with an attractive brilliant external appearance as its characteristic. The techniques are also intended to allow the product to be corrosion-resistant and weatherproof.

In Japanese Patent Application Laid-Open No. 7-31337, there is proposed a tubular member having a coating film formed on its outer surface and an interference coating film formed on the outer surface of the coating film.

In Japanese Patent Application Laid-Open No. 9-122574, there is proposed an interference coating film having a micro-irregular surface formed on the surface of an article, a transparent layer formed on the irregular surface, and a transparent film formed on the transparent layer.

In Japanese Patent Application Laid-Open No. 10-44308, there is proposed a member having a decorative layer including a metal layer formed on the body thereof and a transparent or semitransparent protective layer formed on the metal layer.

In Japanese Patent Application Laid-Open Nos. 7-31337, 9-122574, and 10-44308, painting is used as the method of decorating the tubular member. Therefore owing to nonuniform painting, there is a variation in the thickness of the painted coating film. That is, a decoration layer is not uniform in its thickness. Further since the decoration layer consists of the coating film, the decoration layer is liable to separate from the tubular member owing to repeated use thereof. Thus the decoration layer is incapable of staying on the tubular member for a long time. Moreover, a painting process is required to produce these tubular members by these conventional arts. Thus these tubular members are produced with low productivity and workability.

### SUMMARY OF THE INVENTION

The present invention has been made in view of the above-described problems. Therefore it is an abject of the present invention to provide a tubular member having a construction allowing decoration to be applied uniformly to the surface thereof and preventing a decoration layer from separating therefrom.

To achieve the object, according to the present invention, there is provided a tubular member including a laminate of a plurality of prepregs each containing a matrix resin and a reinforcing fiber impregnated with the matrix resin. A polarizing prepreg whose reinforcing fiber consists of a glass fiber and whose matrix resin contains a polarizing material is disposed at least at an outermost layer of the laminate. The polarizing prepreg and the prepregs other than the polarizing prepreg are formed integrally.

As described above, by disposing the polarizing prepreg at the outermost layer of the laminate and integrating the polarizing prepreg with the other prepregs, it is possible to decorate the tubular member uniformly and prevent separation of the decoration layer containing the polarizing material having a polarizing action from the laminate. Further unlike the conventional art, the tubular member of the present invention can be decorated very easily because the tubular member can be produced without the need of a process the tubular member can be produced without the need of a process of applying polarizing paint thereto. Therefore it is easy to obtain the tubular member that does not have a variation in its thickness and external appearance and is superior in its decorativeness.

The prepreg can be altered easily in its thickness, configuration, and size. Thus a desired range of the tubular member can be decorated easily and uniformly by altering the thickness, size, and configuration thereof. More specifically, the polarizing prepreg is disposed on the surface of the laminate in a predetermined thickness in such a way as to cover the surface of the laminate entirely or partly. When the surface of the laminate is partly covered with the polarizing prepreg, it is preferable to set the configuration of the polarizing prepreg, other prepregs, and a mandrel appropriately and make the surface of the tubular member smooth.

Since the glass fiber is used as the reinforcing fiber of the polarizing prepreg, it is possible to allow it to be transparent and display the effect of the polarizing material to the maximum. The glass fiber may be non-alkali or alkali. The glass fiber is used in the form of long fibers or short fibers. The configuration arrangement and angle of the glass fiber are not limited to specific ones. For example, the glass fiber can be used in a single direction and a random direction and in the form of a sheet, a mat, cloth, and a braid. It is particularly preferable that the glass fiber is cloth-shaped. It is also preferable that the diameter of the glass fiber is 5 μm to 20 μm.

In the present invention, the polarizing prepreg containing the glass fiber allowing the polarizing prepreg to be transparent is disposed essentially at the outermost layer of the body of the tubular member. The number of the polarizing prepregs and the position thereof can be set appropriately. The polarizing prepreg can be disposed partly, intermittently or continuously in the axial and circumferential directions of the tubular member. The polarizing prepreg is wound around the mandrel favorably at an integral number of times and more favorably at one time. However, the polarizing prepreg may be wound around it at 1.5, 2 or 3 times. The layering thickness of the polarizing prepreg is favorably 0.1 mm to 0.5 mm and more favorably 0.1 mm to 0.2 mm. The configuration of the mandrel can be set appropriately in dependence on the disposing manner of the polarizing prepreg and other prepregs.

It is preferable that the content of the polarizing material is set to the range of not less than 0.05 wt % nor more than 3.0 wt % for a predetermined content of the matrix resin of the polarizing prepreg. Thereby the tubular member can be decorated efficiently without affecting other performances thereof adversely.

If the content of the polarizing material is less than the lower limit, it is difficult to realize the decorated external appearance which is a characteristic of the present invention. If the content of the polarizing material is more than the upper limit, it is difficult to heighten the effect of the present invention. It is more favorable to set the content of the polarizing material to the range of 0.1 wt % to 1.0 wt % for a predetermined content of the matrix resin.

The maximum length (particle diameter, length of metal piece) of the polarizing material is set to favorably 1 μm to 100 μm and more favorably 5 μm to 20 μm. If the maximum length of the polarizing material is set less than the lower limit, the polarizing material does not disperse uniformly in the matrix resin. Consequently it is difficult to obtain an external appearance having continuity. On the other hand, if the maximum length of the polarizing material is set more than the upper limit, the polarizing material is too large for the thickness of the polarizing prepreg predetermined by the present invention. Consequently there is a possibility that the tubular member will have a low strength.

As the polarizing material, it is possible to use calcite or the like because of a double refraction of its crystal. It is also possible to use a polymeric film because of its two-tone. It is preferable to use a thin metal piece such as an aluminum foil.

More specifically, the following aluminum foils can be preferably used: CHROMAFLAIR (aluminum foil) manufactured by FLEX PRODUCTS INC.(USA) and HELICONE (aluminum foil) manufactured by Wacker Chemie GmbH (Germany).

It is preferable that the matrix resin of the polarizing prepreg is identical to the matrix resin of other prepregs. Thereby integral molding of the polarizing prepreg and the other prepregs can be accomplished easily. As the matrix resin, resins having a certain degree of transparency are preferable. The following resins can be used singly or in combination: thermosetting resins such as epoxy resin, polyester resin, phenol resin, and polyurethane resin; and thermoplastic resins such as ABS resin, nylon resin, polycarbonate resin, and PEEK resin.

When the tubular member is used as a golf club shaft, the epoxy resin is preferably used as the matrix resin in view of the strength of the tubular member. The tubular member can be used for a tennis racket, a badminton racket, a fishing rod, and skiing goods, and the like in addition to the golf club shaft.

A pattern may be applied to the surface of the laminate by means of silk-screen printing, a transfer foil, a seal, and the like. Thereby it is possible to enhance the decorativeness of the tubular member. Clear painting may be applied to the surface of the laminate to protect the surface thereof in the range in which the decorativeness of the tubular member is not affected thereby adversely.

It is possible to appropriately set the layering number of prepregs other than the polarizing prepreg and the number of turns thereof. As the reinforcing fiber which is used for the prepregs other than the polarizing prepreg, the following fibers which are used as high-performance reinforcing fibers can be used: carbon fiber, graphite fiber, aramid fiber, silicon carbide, alumina fiber, boron fiber, glass fiber, aromatic polyamide fiber, aromatic polyester fiber, ultra-high-molecular-weight polyethylene fiber and the like. Metal fibers may be used. These reinforcing fibers are used in the form of long fibers or short fibers. It is possible to use a mixture of two or more of these fibers. The configuration and arrangement of the reinforcing fibers are not limited to specific ones. For example, they can be used in a single direction and a random direction and in the form of a sheet, a mat, cloth, a braid and the like.

### BRIEF DESCRIPTION OF THE DRAWINGS

FIG. 1A is a schematic view showing a tubular member of a first embodiment of the present invention.

FIG. 1B shows the situation in which prepregs constituting the tubular member are layered one upon another.

FIG. 2A is a schematic sectional view showing the tubular member of the first embodiment in its axial direction.

FIG. 2B is a schematic sectional view showing the tubular member of the first embodiment in its circumferential direction.

FIG. 3 is a schematic sectional view showing a tubular member of a second embodiment in its axial direction.

FIG. 4 is a schematic sectional view showing a tubular member of a modification of the second embodiment in its axial direction.

FIGS. 5A and 5B are a schematic sectional view showing tubular members of other modes in a circumferential direction thereof.

### DETAILED DESCRIPTION OF THE PREFERRED EMBODIMENTS

The embodiments of the present invention will be described below with reference to drawings.

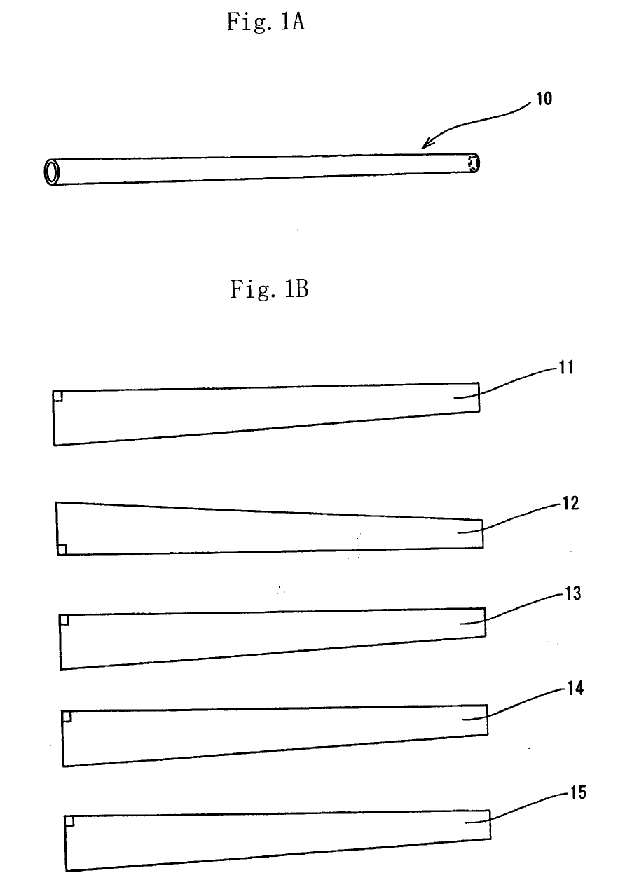

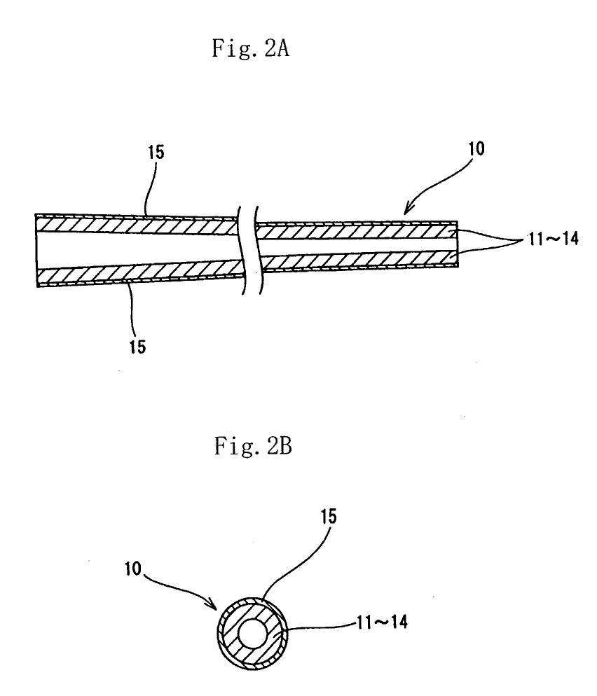

FIGS. 1 and 2 show a tubular member 10 according to a first embodiment of the present invention. The tubular member 10 is hollow pipe-shaped and composed of a laminate of prepregs 11 through 15, shown in FIG. 1B, integrated with one another.

The content of a polarizing material contained in a matrix resin of a polarizing prepreg 15 is set to 0.2 wt % for a predetermined content of the matrix resin. The polarizing prepreg 15 is disposed at an outermost layer of the tubular member 10 in such a way as to cover the entire surface of the laminate of the prepregs 11 through 15. A glass fiber is used as the reinforcing fiber of the polarizing prepreg 15. Epoxy resin is used as the matrix resin of the polarizing prepreg 15.

An aluminum foil (commercial name: CHROMA FLAIR) is used as the polarizing material of the polarizing prepreg 15. The length of the polarizing material (foil) is set to 15 μm. The glass fiber is cloth-shaped in its fibrous mode. The polarizing prepreg 15 is layered uniformly on the prepreg 14 in a thickness of 0.5 mm.

A carbon fiber is used as the reinforcing fiber of the prepregs 11 through 14. The epoxy resin is used as the matrix resin of the prepregs 11 through 14. A core (mandrel) is wound with one ply (one turn) of each of the prepregs 11 through 15.

The tubular member 10 is formed by a sheet-winding method. The prepregs 11 through 15 are wound sequentially (prepregs 11→12→ . . . 15) around the core. After the laminate of the prepregs 11 through 15 is lapped with a tape made of polyethylene terephthalate, integral molding is performed by heating the laminate lapped with the tape in an oven at a certain pressure to harden the resin. Finally the core is drawn from the laminate.

To display an article number and the like on the surface of the tubular member 10 formed in this way, it is possible to print a pattern on the surface thereof by silk-screen printing, polish the surface thereof, and perform clear painting to protect the decoration.

As described above, the polarizing prepreg 15, having a certain thickness, containing the glass fiber serving as its reinforcing fiber is disposed at the outermost layer of the laminate of the prepregs 11 through 14 by winding the polarizing prepreg 15 circumferentially entirely and molding it integrally with the prepregs 11 through 14. Thereby the entire surface of the tubular member 10 can be decorated easily and uniformly. The polarizing prepreg 15 containing the epoxy resin as its matrix resin is molded integrally with the prepregs 11 through 14, also containing the epoxy resin as the matrix resin thereof, constituting the base material of the tubular member 10. Thus the polarizing prepreg 15 is superior in its adhesiveness to the prepreg 14. Thus the decoration never separates from the prepregs 11 through 14.

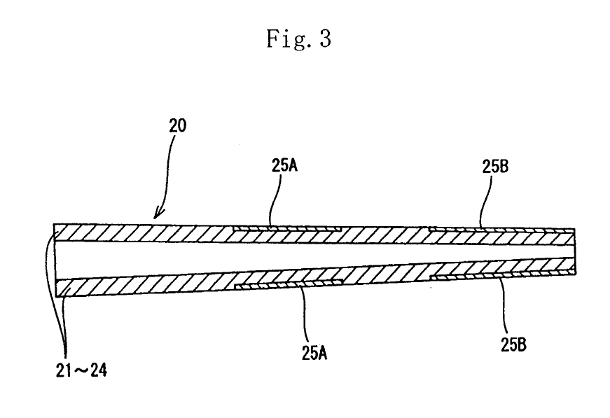

FIG. 3 shows a tubular member 20 of a second embodiment of the present invention. A laminate of the tubular member 20 includes polarizing prepregs 25A and 25B whose reinforcing fiber consists of a glass fiber and whose matrix resin contains a polarizing material. The prepregs 25A and 25B are disposed at the outermost layer of the laminate of the prepregs in such a way as to cover the surface of the laminate partly and make the surface of the tubular member 20 smooth. The prepregs 25A and 25B are integrated with a plurality of prepregs 21 through 24 layered one upon another as the inner layers of the laminate.

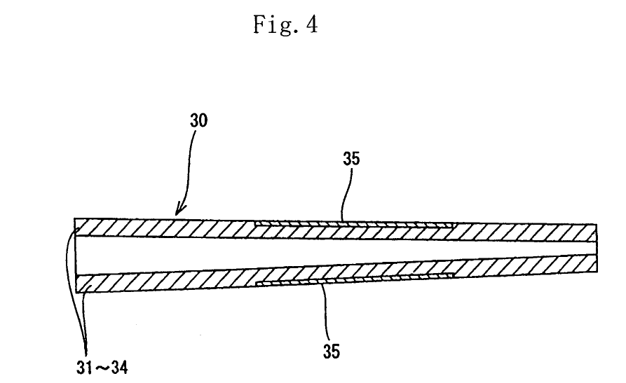

The prepreg 25A constituting the outermost layer is disposed in the neighborhood of the center of the tubular member 20 in its axial direction. The prepreg 25B also constituting the outermost layer is disposed at the tip side of the tubular member 20. Thereby required two portions are decorated with the polarizing prepregs 25A and 25B. As a modification of the second embodiment, a polarizing prepreg 35 is disposed in the neighborhood of the center of a tubular member 30 in its axial direction and integrated with a plurality of prepregs 31 through 34 layered one upon another as the inner layers of the laminate of the prepregs, as shown in FIG. 4.

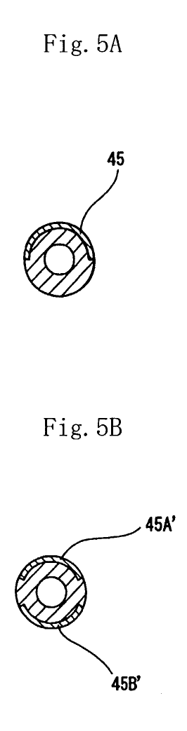

Tubular members having various modes can be formed by setting the size, configuration, thickness, and the like of the polarizing prepreg, prepregs other than the polarizing prepreg, and the configuration of the mandrel. The number of turns of the polarizing prepreg is one in the above-described embodiments. Instead, the number of turns of a polarizing prepreg may be plural. As shown in FIG. 5A, the number of turns of a polarizing prepreg 45 may be semicircular. Alternatively, polarizing prepregs 45A′ and 45B′ may be disposed intermittently, namely, partly in the circumferential direction of a tubular member, as shown in FIG. 5B.

Examples of the tubular member of the present invention and comparison examples will be described below in detail.

As shown in table 1, a surface-decorated tubular member of each of examples 1 through 5 and comparison examples 1 through 3 was prepared. Variations in the thickness of the decoration layer of each tubular member were evaluated. Further the external appearance of each tubular member was visually evaluated. In addition, the period of time required for decoration were evaluated on the tubular member of the comparison examples 1 and 2.

TABLE 1

| | E1 | E2 | E3 | E4 | E5 | CE1 | CE2 | CE3 |
|---|---|---|---|---|---|---|---|---|
| Decoration | Polarizing | Polarizing | Polarizing | Polarizing | Polarizing | Coating | Coating | Prepregs |
| method | prepreg | prepreg | prepreg | prepreg | prepreg | film of | film of | except for |
| | integrally | integrally | integrally | integrally | integrally | polarizing | polarizing | polarizing |
| | molded | molded | molded | molded | molded | paint | paint | prepreg |
| | | | | | | | | integrally |
| | | | | | | | | molded |
| Wt % of | 0.05 | 0.1 | 1 | 3 | 5 | 0.1 | 3 | 0 |
| polarizing | | | | | | | | |
| material | | | | | | | | |
| Variation of | 3 | 5 | 4 | 5 | 4 | 50 | 55 | — |
| thickness of | | | | | | | | |
| decoration | | | | | | | | |
| layer | | | | | | | | |
| Visual | ◯ | ⊚ | ⊚ | ⊚ | ⊚ | Δ | ◯ | X |
| evaluation | | | | | | | | |
| of external | | | | | | | | |
| appearance | | | | | | | | |
| Decoration | — | — | — | — | — | 120 | 120 | — |
| time period | | | | | | | | |
| (minute) | | | | | | | | |

where E1 to E5 denote example 1 to example 5, and CE1 to CE3 denote comparison example 1 to comparison example 3.

### EXAMPLES 1 THROUGH 5

The tubular member of each of the examples had a layering construction of prepregs similar to that of the above-described first embodiment. However, the weight percentage of the polarizing material contained in the polarizing prepreg of each tubular member was altered, as shown in table 1.

The polarizing prepreg was prepared by using a resin mixed with the polarizing material in advance. The thickness of the decoration layer was set to 0.2 mm. To display an article number and the like on the surface of the polarizing prepreg, a pattern was printed on the surface thereof by silk-screen printing, polish the surface thereof, and perform clear painting to protect the decoration.

### COMPARISON EXAMPLES 1 THROUGH 3

After a laminate consisting of wound prepregs other than the polarizing prepreg was heated to harden it, not the polarizing prepreg but the polarizing paint was applied to the surface of the laminate. As in the case of the examples 1 through 5, the thickness of the decorative layer was 0.2 mm. The weight percentage of the polarizing material contained in the polarizing paint was set, as shown in table 1. The tubular member of the comparison example 3 had a construction similar to that of the example 1 but the wt % of the polarizing material contained in the polarizing prepreg was 0 (not decorated).

To display an article number and the like on the surface of the polarizing paint, a pattern was printed on the surface thereof by silk-screen printing, the surface thereof was polished, and clear painting was performed to protect the decoration.

The thickness of the decoration layer of each tubular member was measured at given 10 position to compute the difference (variation: μm) between the maximum thickness of the decoration layer and the minimum thickness thereof. A visual evaluation of the external appearance of each tubular member was made by five persons. The mark of ⊚ of table 1 was given to tubular members when five persons felt the external appearance thereof favorable. The mark of ◯ was given to tubular members when four persons felt the external appearance thereof favorable. The mark of Δ was given to tubular members when two to three persons felt the external appearance thereof favorable. The mark of × was given to tubular members when 0 to one person felt the external appearance thereof favorable. In the case of the tubular members of the comparison examples 1 and 2, the period of time for painting the surface of the tubular member (period of time (minute) required for painting+period of time required for paint to harden) was measured.

As shown in table 1, it was confirmed that the tubular member of the examples 1 through 5 had less variations than those of the comparison examples in the decoration thereof. That is, the tubular member of the examples 1 through 5 had a thickness approximately uniform in the decoration layer thereof and was preferable in the visual evaluation. Since the polarizing prepreg and other prepregs were formed integrally, the decorated tubular members could be obtained easily without spending time for decoration.

In the tubular member of the comparison examples 1 and 2, the coating film was formed on the surface thereof with the polarizing paint. Thus the tubular members had variations in the thickness of the decoration layer thereof. Further since the decoration layer was nonuniform, the external appearance of each of them was less beautiful than those of the examples 1 through 5. After the prepregs other than the decoration layer were hardened, it took much time to paint the prepreg with the polarizing paint. The tubular member of the comparison example 3 had a poor external appearance because the polarizing prepreg nor the polarizing paint was used.

As apparent from the foregoing description, according to the present invention, the polarizing prepreg, containing the glass fiber and the polarizing material is disposed at the outermost layer of the laminate of the other prepregs, the tubular member can be easily set in their thickness, configuration, and size. Therefore it is possible to decorate the tubular member uniformly and prevent separation of the decoration layer containing the polarizing material having a polarizing action from the laminate. Therefore it is easy to obtain the tubular member that does not have a variation in its thickness and external appearance, have polarizing properties, and is superior in its decorativeness.

Further unlike the conventional art, because the tubular member of the present invention can be produced without the need of a process of painting polarizing paint thereon, the tubular member can be decorated very easily. That is, the tubular member can be produced in a simplified process and with a high productivity and workability. Further partial decoration of the tubular member can be accomplished easily. Accordingly the tubular member can be used suitably for a golf club shaft, a tennis racket, a badminton racket, a fishing rod, and the like.

What is claimed is:

1. A tubular member comprising a laminate of a plurality of prepregs each containing a matrix resin and a reinforcing fiber impregnated with said matrix resin,
wherein a polarizing prepreg whose reinforcing fiber consists of a glass fiber and whose matrix resin contains a polarizing material is disposed at least at an outermost layer of said laminate; and
said polarizing prepreg and said prepregs other than said polarizing prepreg are formed integrally.

2. A tubular member according to claim 1, wherein said polarizing prepreg is disposed in such a way as to cover a surface of said laminate entirely or partly.

3. A tubular member according to claim 1, wherein a content of said polarizing material is set to a range of not less than 0.05 wt % nor more than 3.0 wt % for a predetermined content of said matrix resin.

4. A tubular member according to claim 2, wherein a content of said polarizing material is set to a range of not less than 0.05 wt % nor more than 3.0 wt % for a predetermined content of said matrix resin.

5. A tubular member according to claim 1, wherein a matrix resin of said polarizing prepreg is identical to a matrix resin of other prepregs.

6. A tubular member according to claim 2, wherein a matrix resin of said polarizing prepreg is identical to a matrix resin of other prepregs.

7. A tubular member according to claim 3, wherein a matrix resin of said polarizing prepreg is identical to a matrix resin of other prepregs.
